(19) United States
(12) Patent Application Publication
(10) Pub. No.: US 2012/0031519 A1
(43) Pub. Date: Feb. 9, 2012

(54) MULTI-LAYER TUBE FOR AN AUTOMATIC TRANSMISSION

(76) Inventors: Arturo Carrano, Pescara (IT); Mariofelice Zanardi, Torino (IT); Filippo Giannino, Grosseto (IT)

(21) Appl. No.: 13/127,821

(22) PCT Filed: Nov. 5, 2009
(86) PCT No.: PCT/IB09/07352

§ 371 Date: Oct. 25, 2011

(30) Foreign Application Priority Data
Nov. 6, 2008 (IT) TO2008A000821

(51) Int. Cl. F16L 9/14

(52) U.S. Cl. 138/140

(57) ABSTRACT

A multilayer tube for an automatic transmission, the multilayer tube comprising at least one layer of elastomeric material resistant to oils, in particular to DEXRON VI. Advantageously, the layer of elastomeric material is a mixture of CSM (polyethylene chlorosulphonate) and EVM in which the percentage ratio between EVM and CSM is comprised between 4:1 and 1:1.

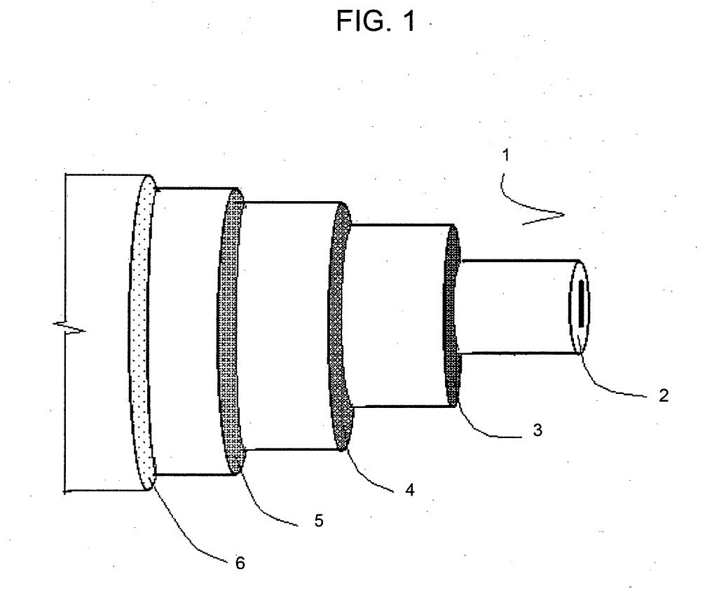

### TECHNICAL FIELD

The present invention relates to a multilayer tube comprising at least one layer of elastomeric material used, in particular, in automatic transmissions of motor vehicles.

### BACKGROUND ART

As is known, automatic transmissions of motor vehicles of recent conception use special oils that enable an increase in service life and better operation thereof in extreme conditions. Transport of said oils in automatic-transmission system calls for tubes having very good mechanical characteristics and characteristics of resistance to oils.

Said special oils generally consist of lubricating oils to which a multiplicity of agents having antioxidant, antifoaming, antiwear functions, etc., are added, with the purpose of improving performances as compared to the special oils of previous conception. In particular, the introduction of said additional agents has the purpose of extending the service life of the transmission system in so far as they protect the mechanical elements of the transmission from the lubricating oil itself. On the other hand, since said agents comprise basic substances and phosphates, they prove particularly aggressive in regard to the rubbers used for the pipes responsible for their transport on board the motor vehicle.

Recently, new oils for automatic transmissions have been introduced. In particular, an oil called DEXRON®-VI ATF has found use for automatic transmissions of automobiles and commercial vehicles.

DEXRON® is formulated so as to present an improved resistance to oxidation and friction, stability to shear, and resistance to formation of foam, and moreover enables a longer service life to be obtained as compared to the oils previously used in automatic transmissions.

Unfortunately, said oil has proven particularly aggressive in regard to numerous types of polymers of which the tubes used in automatic-transmission and servosteering systems are generally made.

Under study are numerous alternative solutions; for instance, the use of HNBR mixes is known.

However, notwithstanding the promising results obtained from testing HNBR pipes, the particularly high cost of this elastomer renders said solution unacceptable from the economic standpoint for automobile manufacturers. There is consequently felt on the market the concrete need to identify alternative compositions.

None of the mixes so far proposed enables, however, the tests required by the specifications of automobile manufacturers to be passed.

### DISCLOSURE OF INVENTION

The aim of the present invention is to provide a tube made of plastic and oil-resistant material that will be able to replace the tubes currently used and that will be usable in automatic-transmission and servo-steering systems that employ DEXRON VI oil, overcoming the technical specifications required by automobile manufacturers.

In particular, the above aim is achieved by providing a tube according to claim 1. According to a preferred embodiment of the present invention, a multilayer tube including at least one internal layer comprising a mixture of EVM and CSM is provided.

### BRIEF DESCRIPTION OF THE DRAWING

For a better understanding of the present invention, the latter is further described also with reference to the attached FIGURE, which shows a partial cross-sectional view of a multilayer tube 1 provided according to the present invention.

### BEST MODE FOR CARRYING OUT THE INVENTION

The tube according to the present invention is produced following the steps of the known process of production of tubes made of elastomeric material, whilst the materials used and the combinations thereof prove innovative.

The tube 1 comprises at least one layer 2 comprising a mixture of an ethylene and vinyl-acetate copolymer, also commonly known as, and referred to in what follows, by the acronym EVM, and an ethylene and chlorosulphonate copolymer, which is also commonly known, and will be referred to in what follows, by the acronym CSM.

EVM or ethylene covinyl acetate copolymer used in the rubber industry is produced by copolymerization in a solution of ethylene and vinyl acetate at pressures of between 200 and 1000 bar and at temperatures of between 50° C. and 120° C.

For example, the internal layer 2 comprises the EVM polymer marketed by Lanxess under the registered trade mark Levapren®, for example Levapren® 700 HV, which contains 70 wt % of vinyl acetate.

By the term “CSM” or “polyethylene chlorosulphonate” reference is made to a group of chemically modified polyolefins containing chlorine and sulphonyl chloride groups, which possess elastomeric properties. They are obtained by causing reaction of a mixture of chlorine and sulphur dioxide, sulphuryl chloride and a weak base, or else sulphuryl chloride and chlorine on polyolefin polymers preformed in the presence of an initiator. The resulting polymer can contain between 20% and 60% of chlorine groups and between 1% and 5% of sulphur in the form of sulphonyl-chloride groups. The chlorine groups have the function of reducing the crystallinity of the polymer from which they derive and bestow upon the resulting material useful chemical properties, such as resistance to oils, to oxidizing agents, to ozone, and good thermal resistance. The sulphonyl-chloride groups react with bivalent metal oxides, sulphides or radicals to form stable lattices. The mechanical characteristics of the crude polymer and of the vulcanized polymer are a function of the molecular weight and of its distribution, and of the presence of branchings in the starting polyolefin. For instance, the internal layer 2 can contain CSM marketed by DuPont under the trade mark Hypalon®, such as for example Hypalon® 4085.

Preferably, in the internal layer 2, the percentage ratio between EVM and CSM is comprised between 1:1 and 4:1 (80:20).

More preferably, in the internal layer 2 the percentage ratio between EVM and CSM is comprised between 1:1 and 3:1 (75:25).

Pure EVM has relatively low Mooney viscosity values, generally comprised between 25 and 30. Said characteristic renders the operations of extrusion complex so that a higher viscosity value is preferable. This increase is achieved precisely by mixing EVM with CSM, which in general has a higher Mooney viscosity, with values usually comprised between 50 and 100. In this way, the mix according to the invention has intermediate viscosity values between the ones usually recorded for the respective components, which advantageously simplify the operations of extrusion and eliminate the need of resort to fillers to overcome the problem.

On the other hand, using mixes with EVM:CSM ratios of less than 1:1 there is noted a deterioration of the resulting mechanical properties (see also the data obtained in the examples), which render the tube not suitable for responding to the requirements imposed by the automobile manufacturers. In addition, pure CSM has a decidedly limited compatibility with Dexron® VI (see the comparative example 6). Consequently, an excessively high content of CSM in the mixture would also entail an undesirable decrease in the compatibility of the mixture itself with the oil for transmissions.

The internal layer 2 can be formed with the processes of extrusion well known to the person skilled in the branch. Its thickness can vary according to the polymer chosen as base material, and is on average comprised between 1 and 2 mm, preferably between 1.2 and 1.8 mm, even more preferably is approximately 1.4 mm.

The internal diameter of the tube 1 may vary preferably between 5 and 12 mm, more preferably between 6 and 10 mm.

The internal layer 2 can moreover contain conventional additives, such as, for example, plasticizing agents, vulcanizing agents, antioxidants, fillers, etc.

To the internal layer 2 of the tube according to the invention there layers of a different chemical nature can be furthermore associated.

The tube 1 can moreover comprise one or more reinforcement layers 3, 5 comprising a reinforcement mesh. Said reinforcement mesh comprises fibres obtained from a polymer chosen in the group constituted by aliphatic polyamides, aromatic polyamides, polyesters. Preferably, the reinforcement layer 3, 5 comprises fibres obtained from aromatic polyamides.

Between the barrier layer 4 and the reinforcement mesh 5 there can optionally be set a second internal layer preferably chosen in the group constituted by acrylonytril/butadiene, hydrogenated acrylonytril/butadiene, polyethylene chlorosulphonate, EPDM, polyethylene hydrochloride. The thickness of this second internal layer varies obviously according to the polymer chosen, but is normally comprised between 0.25 and 1.50 mm, and preferably between 0.45 and 0.65 mm.

Advantageously, on the layers described previously, a cover layer 6 can be extruded, comprising, for example, polymers chosen in the group constituted by polyethylene chlorosulphonate, HNBR, mixtures of acrylonytril/butadiene and PVC, polyethylene hydrochloride, EPDM, chloroprene, EVA and EVM. Preferably, the elastomers used in the layer 6 are CSM, CPE, EVM or mixtures thereof. The thickness of the cover layer 6 depends upon the nature of the polymer that constitutes it and can range from 1 mm to 2 mm, and is preferably between 1.2 and 1.8 mm. Even more preferably, said thickness is approximately 1.4 mm.

In particular, the structure of the multilayer tube 1 of the present invention shows surprising qualities of resistance to aggressive chemical agents, and, more particularly, to the new oils for automatic transmissions. Research in the sector of the lubricating oils has pointed to the development of new compositions that have an increasingly regular profile of viscosity, which enables high levels of performance even in extreme conditions and limits the degradation of the properties of the lubricant over time. In particular, the requirements have been raised as regards stability to shear and oxidative stability.

Parameters of particular importance for a lubricating oil are the viscosity index and the pour point. The viscosity index, a characteristic expressed according to a conventional scale adopted in the petroleum industry, substantially expresses the variation of viscosity with temperature. Considering two lubricants, given the same viscosity at 40° C., the one with higher viscosity index guarantees an easier starting at low temperature (lower internal friction) and a degree of separation of the surfaces (a thickness of lubricating film) that is higher at high temperatures. The pour point is the minimum temperature at which a lubricant continues to flow when it is cooled. Below the pour point, the oil tends to “thicken” and no longer flows freely.

A lubricating oil for automatic transmissions has, in general, a viscosity index of between 140 and 200 and a pour point lower than −40° C.

In particular, the structure of the multilayer tube 1 is resistant in regard to a particularly aggressive oil such as DEXRON®-VI ATF. The structure of the multilayer tube 1 of the present invention combines said surprising characteristics of chemical resistance with mechanical performance that render it suitable for numerous applications on board a motor vehicle. The burst pressure of a tube according to the present invention is higher than 300 bar.

In addition, it has a contained cost and is flexible, thus enabling easy installation and a high degree of freedom in arrangement of the components in the engine compartment.

Finally, it is clear that modifications may be made to the multilayer tube described and illustrated herein, in particular, as regards the percentage ratio of the chemical components constituting the various layers and the relative thicknesses of the layers, as well as the number of the layers themselves, without thereby departing from the sphere of protection of the present invention. For example, a further internal layer and a further reinforcement layer made of textile material may be present.

The invention will now be described by way of examples, but is not, however, limited to these.

### Examples 1-6

A multilayer tube according to the present invention was produced by extruding, according to the known techniques and in known conditions, a layer constituted by a mixture of EVM and CSM.

In particular, the mixtures having compositions (expressed in phr) appearing in Tables 1 and 2 below were subjected to experimental tests and were compared with a mixture comprising only EVM.

TABLE 1

| | Comparative - I | II | III | IV |
|---|---|---|---|---|
| Hypalon 4085 | | 25 | 25 | 50 |
| Levapren 700HV | 100 | 75 | 75 | 50 |
| MgO | 5 | 5 | 5 | 5 |
| ZnO | 5 | | | |
| CaCO₃ | 15 | 15 | 15 | 15 |
| ZMBI | 0.4 | | | |
| Naugard 445 | 1.1 | | | |
| Irganox 1425WL | | 1 | 2 | |
| N550 | 60 | 60 | 60 | 60 |
| Talcum | 20 | 20 | 20 | 20 |
| Plasticizer | 25 | 25 | 25 | 25 |
| PCD-50 | 3 | 1 | | 0.5 |
| Perkadox 14/40 | 4.5 | 4.5 | 4.5 | 4.5 |
| Vulcanizing Agent | 1 | 1 | 1 | 1 |
| TMQ | | 25 | 25 | 0.1 |
| Total | 240.00 | 232.50 | 232.50 | 231.10 |

TABLE 2

| | V |
|---|---|
| Hypalon 4085 | 60 |
| Levapren 700HV | 40 |
| CaCO3 | 25 |
| PE wax | 4 |
| Activator | 3 |
| MgO | 8 |
| Plasticizer | 25 |
| N772 | 75 |
| vulcanizing co-agent | 5 |
| DCP 70 | 4.5 |
| Antioxidant | 0.1 |
| Total | 249.60 |

The mixes I, II, III, IV and V were characterized from the physical and mechanical standpoint by measurement of the respective ultimate strength, ultimate elongation, and hardness (repeated after ageing for 72 h at 150° C., respectively in air and in Dexron VI), and determination of the melting point by means of DSC.

The data obtained are given in Table 3 below.

TABLE 3

| | Unit of | | | | | |
|---|---|---|---|---|---|---|
| | measure- | | | | | |
| Type of test | ment | I | II | III | IV | V |
| Ultimate | [MPa] | 10 | 13 | 12 | 10 | 14 |
| strength | | | | | | |
| upon supply | | | | | | |
| Ultimate | [%] | 302 | 186 | 189 | 286 | 102 |
| elongation | | | | | | |
| upon supply | | | | | | |
| Hardness | [ShA] | 69 | 77 | 76 | 72 | 77 |
| upon supply | | | | | | |
| Variation of | [MPa] | 10.26 | 11.38 | 10.87 | 8.82 | 13.67 |
| ultimate | | | | | | |
| strength | | | | | | |
| after 72 h | | | | | | |
| at 150° C. in | | | | | | |
| air | | | | | | |
| | [Δ %] | 0.69 | −12.33 | −12.20 | −11.98 | −3.87 |
| Variation of | [%] | 283.25 | 174.25 | 182.95 | 224.62 | 102.27 |
| ultimate | | | | | | |
| elongation | | | | | | |
| after 72 h | | | | | | |
| at 150° C. in | | | | | | |
| air | | | | | | |
| | [Δ %] | −6.18 | −6.29 | −3.11 | −21.57 | 0.38 |
| Variation of | [ShA] | 2.4 | 8 | 5 | 4.2 | 2.2 |
| hardness | | | | | | |
| after 72 h | | | | | | |
| at 150° C. in | | | | | | |
| air | | | | | | |
| Variation of | [MPa] | 9.87 | 11.37 | 10.23 | 10.31 | 9.75 |
| ultimate | | | | | | |
| strength | | | | | | |
| after 72 h | | | | | | |
| at 150° C. in | | | | | | |
| Dexron VI | | | | | | |
| | [Δ %] | −3.11 | −12.40 | −17.37 | 2.89 | −31.43 |
| Variation of | [%] | 320.35 | 121.08 | 121.28 | 143.21 | 75.67 |
| ultimate | | | | | | |
| elongation | | | | | | |
| after 72 h | | | | | | |
| at 150° C. in | | | | | | |
| Dexron VI | | | | | | |
| | [Δ %] | 6.11 | −34.89 | −35.77 | −50.00 | −25.73 |
| Variation of | [ShA] | 3.8 | 3.6 | 3 | 2.4 | −3 |
| hardness | | | | | | |
| after 72 h | | | | | | |
| at 150° C. in | | | | | | |
| Dexron VI | | | | | | |
| Variation of | % | −2.28 | −0.43 | 0.21 | 4.79 | 6.64 |
| volume after | | | | | | |
| 72 h to | | | | | | |
| 150° C. in | | | | | | |
| Dexron VI | | | | | | |

In general, the properties of decay in air for the EVM/CSM mixes according to the invention are good. After prolonged exposure to Dexron VI, for the EVM/CSM mixes very limited variations of volume were recorded, accompanied by substantially negligible variations of hardness, which indicate a surprisingly good compatibility between said rubbers and Dexron VI.

From a comparison between the various mixes, it appears clearly that the co-presence of EVM and CSM in the ratio range of the invention always brings about a limited increase in volume after ageing in Dexron® VI. In particular, it is always lower than 5%, a value that indicates a good chemical compatibility with the transmission oil and falls within the limits required by automobile manufacturers. Advantageously, then, the mechanical properties of the EVM/CSM mixes within the interval according to the present invention prove less markedly affected by prolonged exposure to Dexron VI from the mechanical standpoint. For the mix IV, in particular, the value of ultimate strength remains substantially unvaried after ageing in Dexron VI.

Table 4 below finally gives data obtained with the comparative mix VI containing only CSM and not EVM.

TABLE 4

| | After 72 h at 150° C. |
|---|---|
| Comparative example VI - only CSM | in Dexron ® VI |
| Variation in hardness after 72 h at | −13.5 |
| 150° C. in air [ShA] | |
| Ultimate elongation [%] | 40 |
| Variation of ultimate elongation [%] | 70.4 |
| Variation of ultimate strength [%] | 66.1 |
| Variation of volume [%] | 29.5 |

It appears clearly that CSM, alone, is particularly sensitive to Dexron® VI to the point that prolonged exposure to the latter brings about a considerable deterioration of the mechanical characteristics thereof and, at the same time, also a significant and undesirable swelling that is an index of poor compatibility with the transmission oil.

1. A multilayer tube (1) for conveying hydrocarbons, the multilayer tube (1) comprising at least one internal layer (2) made of elastomeric material, characterized in that said internal layer (2) comprises a mixture of ethylene covinyl acetate copolymer (EVM) and ethylene and chlorosulphonate copolymer (CSM) in which the EVM:CSM ratio is comprised between 4:1 and 1:1.

2. The multilayer tube (1) according to claim 1, characterized in that said EVM:CSM ratio is comprised between 3:1 and 1:1.

3. The multilayer tube (1) according to claim 1, characterized in that said internal layer (2) has a thickness of between 1 and 2 mm.

4. The multilayer tube (1) according to claim 1, characterized by comprising at least one reinforcement yarn (3, 5), said reinforcement yarn comprising fibres obtained from a polymer selected from the group consisting of aliphatic polyamides, aromatic polyamides, polyesters.

5. The multilayer tube (1) according to claim 1, characterized by comprising a cover layer (6) comprising a material chosen in the group constituted by polyethylene chlorosulphonate, HNBR, mixtures of acrylonytril/butadiene and PVC, polyethylene hydrochloride, EPDM, chloroprene, EVA and EVM and mixtures thereof.

6. Use of a multilayer tube according to claim 1 for conveying a transmission oil.

7. Use according to claim 6, characterized in that said oil is a lubricating oil for automatic transmissions having a viscosity index comprised between 140 and 200 and a pour point lower than −40° C.

8. An automatic-transmission system for a motor vehicle comprising a tube according to claim 1.
